(19) United States
(12) Patent Application Publication
(10) Pub. No.: US 2017/0163576 A1
(43) Pub. Date: Jun. 8, 2017

(54) ELECTRONIC DEVICE AND METHOD FOR OPERATION THEREOF

(71) Applicant: Acer Incorporated, New Taipei City (TW)

(72) Inventors: Yu-Chun CHEN, New Taipei City (TW); Huang-Kai CHEN, New Taipei City (TW)

(21) Appl. No.: 15/079,459

(22) Filed: Mar. 24, 2016

(30) Foreign Application Priority Data
Dec. 8, 2015 (TW) 104141057

(51) Int. Cl. H04L 12/58

(52) U.S. Cl. CPC H04L 51/04

(57) ABSTRACT

The present invention provides an electronic device including a display device, and a processor. When the content of a packet message of the instant messaging software is provided with specific content, the processor filters the specific content from the content of the packet message to serve as the main content. When the ratio of a specific language of the main content to the main content is greater than a first predetermined value, the processor displays a specific input interface corresponding to the specific language on the display device.

### CROSS REFERENCE TO RELATED APPLICATIONS

This Application claims priority of Taiwan Patent Application No. 104141057, filed on Dec. 8, 2015, the entirety of which is incorporated by reference herein.

### BACKGROUND OF THE INVENTION

Field of the Invention

The present invention relates to an electronic device, and in particular to an electronic device capable of automatically switching user input interfaces.

Description of the Related Art

It is common for users to use instant messaging software on portable devices such a tablet PC, a smartphone, or the like. In addition, in the current age of globalization and internationalization, many users have friends from many different countries, and these users have to manually switch their user input interfaces on their instant messaging software when using this instant messaging software to have a dialogue with a friend from another country in which a different language is spoken. This situation may cause instant messaging software to become inconvenient for users.

### BRIEF SUMMARY OF THE INVENTION

One object of the present invention is automatically switching a user's input interface to an appropriate input interface according to the language that the user is using to input text, so that the above problems are solved.

The present invention provides an embodiment of an electronic device including a display device, and a processor. The processor filters specific content from the content of a packet message to serve as the main content when the content of the packet message of the instant messaging software is provided with the specific content and displays a specific input interface corresponding to a specific language on the display device when the ratio of the specific language of the main content to the main content is greater than a first predetermined value.

The present invention also provides an embodiment of an operation method of electronic device, including: filtering specific content from the content of a packet message to serve as the main content when the content of the packet message of the instant messaging software is provided with the specific content, and displaying a specific input interface corresponding to a specific language on the display device when the ratio of the specific language of the main content to the main content is greater than a first predetermined value.

The present invention can be used for analyzing, detecting, counting, recording signature phrases and greetings of the user and the people that the user is talking to, using the instant messaging software. If the language of the signature phrases and greetings (for example: good morning, the weather is great, and the like) are not the customary language of the user and are not provided with the meaning of complicated conversation, the present invention takes the signature phrases and greetings as a special string of content of package message and takes the signature phrases and greetings as one of the filtering conditions for the electrical device. However, the mechanism to determine whether the signature phrases are provided with the meaning of complicated conversation is not only based on the common conversations of the user, but also based on the library of Internet search engines (for example: Google, Bing, and the like).

The present invention can be more fully understood by reading the subsequent detailed description and examples with references made to the accompanying drawings, wherein:

### BRIEF DESCRIPTION OF THE DRAWINGS

FIG. 1 is a schematic diagram of an electronic device according to an embodiment of the present invention;

FIG. 2 is a schematic diagram of a display device of an electronic device when the processor operates according to an embodiment of the present invention;

FIG. 3 is a schematic diagram of a display device of an electronic device when the processor operates according to an embodiment of the present invention;

FIG. 4 is a schematic diagram of a display device of an electronic device when the processor operates according to an embodiment of the present invention;

FIG. 5 is a flowchart of an electronic device according to an embodiment of the present invention;

FIG. 6 is a flowchart of an electronic device according to an embodiment of the present invention.

### DETAILED DESCRIPTION OF THE INVENTION

The present invention will be discussed in detail in the examples of a variety of methods described. However, it should be noted that many viable concepts provided by the present invention may be implemented in a variety of specific ranges. These specific examples are merely illustrative of the manufacturing and the usage method of the present invention, but they are not intended to limit the scope of the present invention.

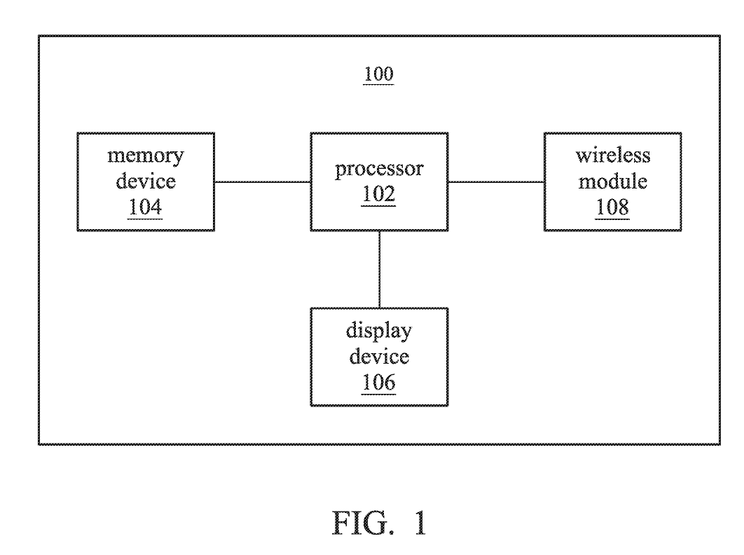

FIG. 1 is a schematic diagram of an electronic device 100 according to an embodiment of the present invention. As shown in FIG. 1, the electronic device 100 may be implemented in a variety of computer system configurations (for example: a smartphone, a tablet computer, a personal digital assistant, and the like). The electronic device 100 includes a processor 102, a memory device 104, a display device 106, and a wireless module 108. In one embodiment of the present invention, the wireless module 108 receives a plurality of packet messages of the instant messaging software (for example: LINE, WeChat, Windows Live Messenger, and the like). In one embodiment of the present invention, the display device 106 may be a light-emitting diode (LED), a liquid-crystal diode (LCD), an organic light-emitting semiconductor diode (OLED) or the like. The display device 106 displays a screen corresponding to screen data according to screen information from the processor 102. In one embodiment of the present invention, the memory 104 may include read-only memory (ROM), flash read-only memory (flash ROM) and/or random access memory (RAM), for storing program modules in the executions of the processor 102. Generally, the program modules often contain routines, programs, objects, components, and the like to perform functions of dynamic information transmission or reception. In one embodiment of the present invention, the memory 104 stores specific content, including a web address, a telephone number, a punctuation mark and/or a default message. For example, the default message is one special string set by the user, for example: “XD”, “orz”, and the like. The memory device 104 can also store a plurality of packet messages sequentially. In one embodiment of the present invention, the processor 102 stores the received packet message to the memory device 104 sequentially through the wireless module 108. The packet message described in the examples of the present invention is the latest packet message received by a conversation window of the instant messaging software. The processor 102 may comprise a single central processing unit (CPU) or a plurality of parallel processing units related to a parallel processing environment, for executing and performing all actions of the electronic device 100. In one embodiment of the present invention, the processor 102 filters the specific content from the content of the packet message to serve as the main content, when the content of a packet message of the instant messaging software is provided with specific content. The processor 102 displays a specific input interface corresponding to the specific language on the display device 106 when the ratio of the specific language of the main content to the main content is greater than a first predetermined value.

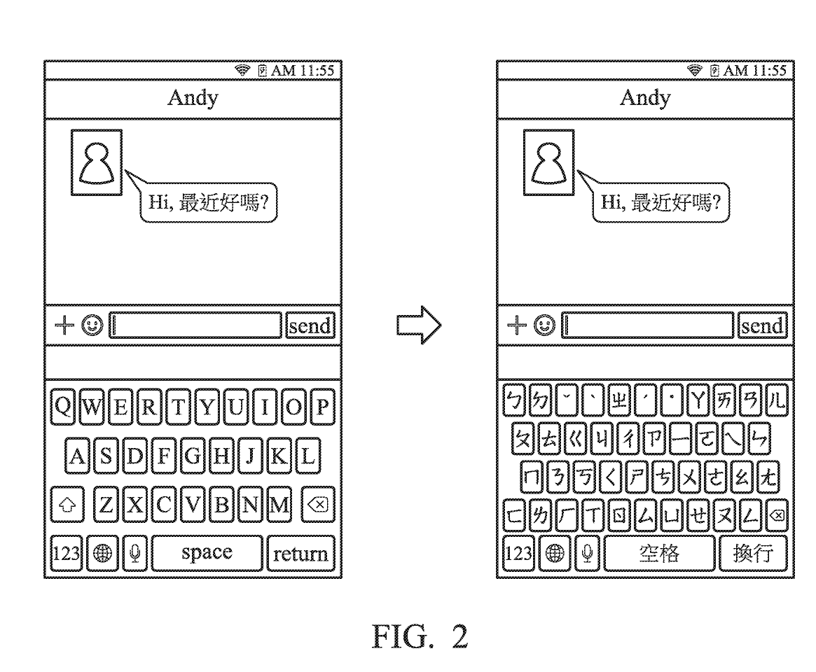

FIG. 2 is a schematic diagram of the display device 106 of the electronic device 106 when the processor 102 operates according to an embodiment of the present invention. As shown in FIG. 2, the display device 106 displays the content of a package message of a conversation window of the instant messaging software received by the processor 102. In one embodiment of the present invention, the instant messaging software is LINE, and the languages of the content of the package message are Chinese and English. For example, the display device 106 shows the content of the package message “Hi, [symbol] ?”, the meaning of the content of the package message is “Hi, how do you do?”, and the punctuation marks “,” and “?” are the specific content. Then, the processor 102 filters the specific content from the content of the packet message to serve as the main content. In the embodiment of the present invention, the processor 102 filters the punctuation marks “,” and “?”, so the filtered main content is “Hi [symbol] ”. Then, the processor 102 performs a language analysis on the main content to determine the language type of the content language and the number of characters corresponding to a variety of languages. Then, the processor 102 can further calculate the ratio of the specific language of the main content to the main content. If the ratio of the specific language of the main content to the main content is greater than a first specific value (for example: 65%), the processor 102 displays a specific input interface corresponding to a specific language on the display device 106. In the embodiment of the present invention, the ratio of Chinese to the main content is 66% (4/6), and the ratio of English to the main content is 33% (2/6), so the specific input interface is a Chinese input interface. In some embodiments of the present invention, “Hi” can be regarded as specific content. In one embodiment of the present invention, the processor 102 uses the content of the package message to serve as the main content directly when the content of the packet message of the instant messaging software is not provided with specific content. In another embodiment of the present invention, the processor 102 performs the language analysis on a number of the words corresponding to the variety of languages, not the number of the characters.

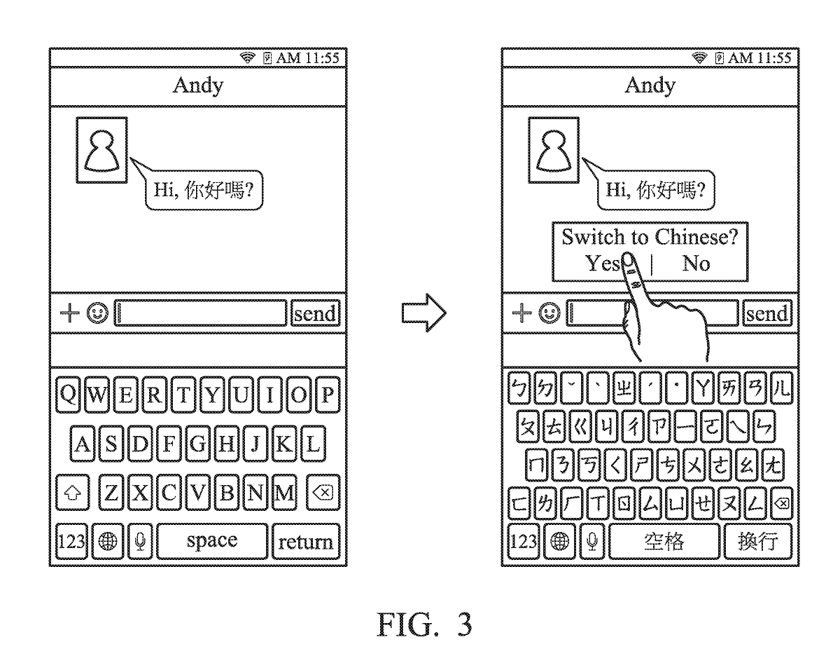

FIG. 3 is a schematic diagram of the display device 106 of the electronic device 106 when the processor 102 operates according to an embodiment of the present invention. As shown in FIG. 3, the display device 106 displays the content of a package message of a conversation window of the instant messaging software received by the processor 102. In one embodiment of the present invention, the instant messaging software is LINE, and the languages of the content of the package message are Chinese and English. For example, the display device 106 shows the content of the package message “Hi, [symbol] ?”, the meaning of the content of the package message is “Hi, how are you?”, and the punctuation marks “,” and “?” are the specific content. Then, the processor 102 filters the specific content from the content of the packet message to serve as the main content. In the embodiment of the present invention, the processor 102 filters the punctuation marks “,” and “?”, so the filtered main content is “Hi [symbol] ”. Then, the processor 102 performs a language analysis on the main content to determine the language type of the content language and a number of characters corresponding to a variety of languages. The processor 102 can further calculate the ratio of the specific language of the main content to the main content. If the ratio of the specific language of the main content to the main content is between the first specific value (for example: 65%) and a second specific value (for example: 55%), the processor 102 displays a control interface on the display device 106. In the embodiment of the present invention, the ratio of Chinese to the main content is 60% (3/5) and the ratio of English to the main content is 40% (2/5), so the processor 102 displays the control interface on the display device 106. Then, the control interface displays two touching areas (touching area “YES” and touching area “NO”). In addition, the first predetermined value has to be greater than the second predetermined value. Then, the first predetermined value and the second predetermined value can be adjusted by the user. Next, the processor 102 displays the specific input interface of the specific language on the display device 106 when the touching area “YES” is touched during a predetermined time interval. In one embodiment of the present invention, the predetermined time interval is 500 ms, and the predetermined time interval can be adjusted by the habit of the user. For example, the processor 102 displays the Chinese input interface on the display device 106 if the touching area “YES” of the control interface is touched by the user during 500 ms. Conversely, the processor 102 displays the input interface corresponding to English (a default input interface) on the display device 106 if the touching area “YES” of the control interface is not touched by the user during 500 ms.

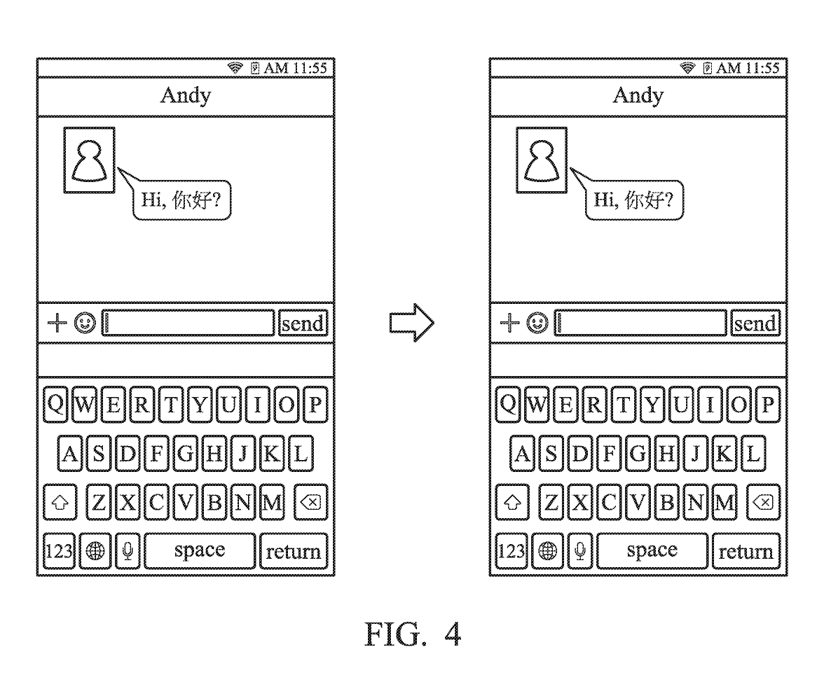

FIG. 4 is a schematic diagram of the display device 106 of the electronic device 106 when the processor 102 operates according to an embodiment of the present invention. As shown in FIG. 4, the display device 106 displays content of a package message of a conversation window of the instant messaging software received by the processor 102. In one embodiment of the present invention, the instant messaging software is LINE, and the languages of the content of the package message are Chinese and English. For example, the display device 106 shows the content of the package message “Hi, [symbol] ?”, the meaning of the content of the package message is “Hi, hello?”, and the punctuation marks “,” and “?” are the specific content. Then, the processor 102 filters the specific content from the content of the packet message to serve as the main content. In the embodiment of the present invention, the processor 102 filters the punctuation marks “,” and “?”, so the filtered main content is “Hi [symbol] ”. Then, the processor 102 performs a language analysis on the main content to determine the language type of the content language and a number of characters corresponding to a variety of languages. And, the processor 102 can further calculate the ratio of the specific language of the main content to the main content. If the ratio of the specific language of the main content to the main content is less than a second specific value (for example: 55%), the processor 102 displays the default input interface on the display device 106. In the embodiment of the present invention, the ratio of Chinese to the main content is 50% (2/4), and the ratio of English to the main content is 50% (2/4), so the processor 102 displays an English input interface on the display device 106.

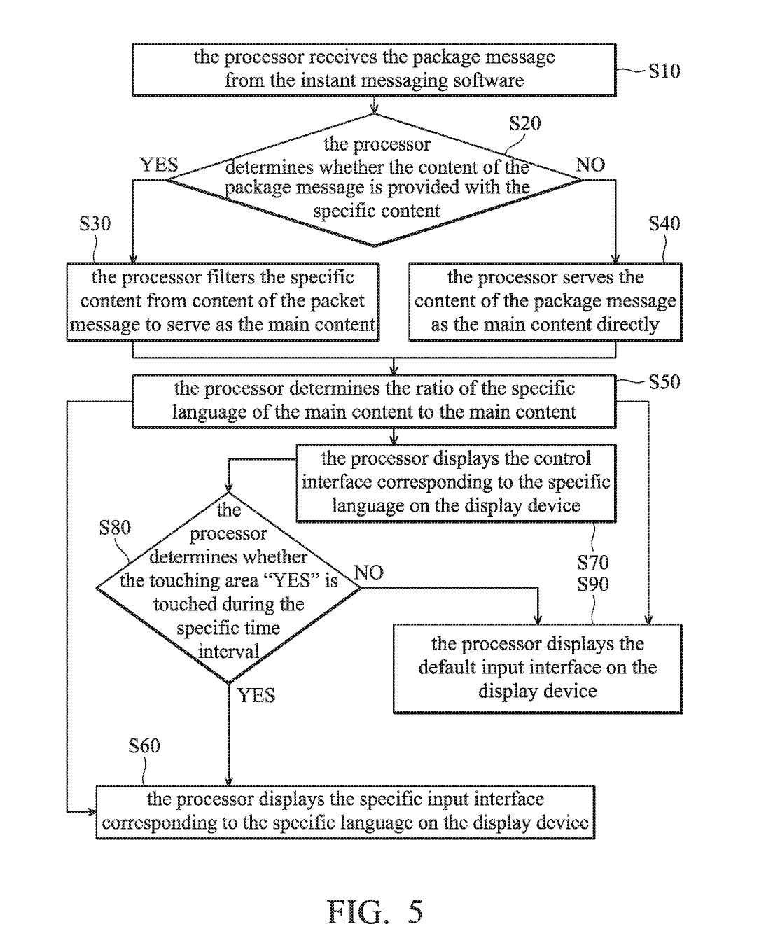

FIG. 5 is a flowchart of an electronic device according to an embodiment of the present invention. First, in step S10, the processor 102 receives the package message from the instant messaging software, and then the flowchart goes to step S20. In step S20, the processor 102 determines whether the content of the package message is provided with specific content. If the content of the package message is provided with the specific content, the flowchart goes to step S30. In step S30, the processor 102 filters the specific content from the content of the packet message to serve as the main content, and the flowchart goes to S50. For example, the specific content can be a web address, a telephone number, a punctuation mark and/or a default message, and the default message is a special string (for example: “XD”, “orz”, and the like) set by the user. If the content of the package message is not provided with the specific content, the flowchart goes to step S40. In step S40, the processor 102 uses the content of the package message as the main content directly. Then, the flowchart goes to step S50. In step S50, the processor 102 determines the ratio of the specific language of the main content to the main content, wherein the first predetermined value is greater than the second predetermined value. If the ratio of the specific language of the main content to the main content is greater than the first predetermined value, the flowchart goes to step S60. In step S60, the processor 102 displays the specific input interface corresponding to the specific language on the display device 106. If the ratio of the specific language of the main content to the main content is between the first predetermined value and the second predetermined value, the flowchart goes to step S70. In step S70, the processor 102 displays the control interface corresponding to the specific language on the display device 106. Then, the flowchart goes to step S80. In step S80, the processor 102 determines whether the touching area “YES” is touched during the specific time interval. If the touching area “YES” is touched during the specific time interval, the flowchart goes to step S60. If the touching area “YES” is not touched during the specific time interval, the flowchart goes to step S90. In step S90, the processor 102 displays the default input interface on the display device 106, wherein the default input interface is different from the specific input interface, and the first predetermined value is greater than the second predetermined value. If the ratio of the specific language of the main content to the main content is less than the second predetermined value, the flowchart goes to step S60.

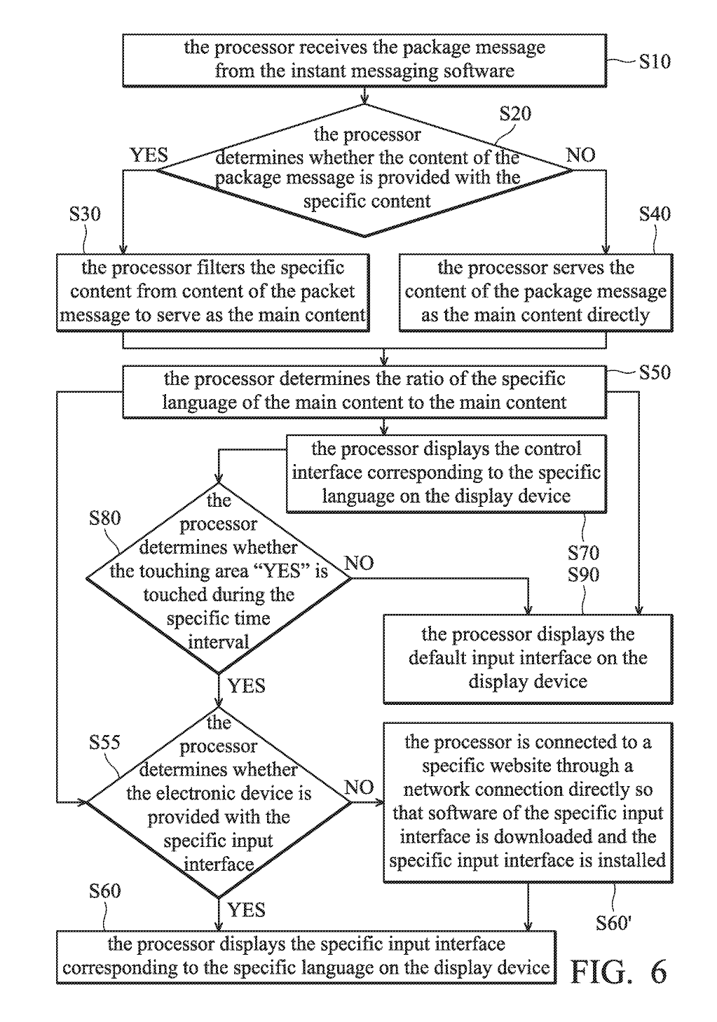

FIG. 6 is a flowchart of an electronic device according to an embodiment of the present invention. The differences from FIG. 5 are step S55 and step S60′. In step S55, the processor 102 determines whether the electronic device 100 is provided with a specific input interface. If the electronic device 100 is provided with a specific input interface, the flowchart goes to step S60. If the electronic device 100 is not provided with a specific input interface, the flowchart goes to step S60′. In step S60′, the processor 102 is directly connected to a specific website through a network connection so that the software of the specific input interface is downloaded and the specific input interface is installed. Then, the flowchart goes to step S60.

As shown in FIGS. 2-5, the technique of the present invention is applicable in a variety of situations. In one embodiment of the present invention, when the user does not open a conversation window (situation 1), the processor 102 receives a plurality of package messages through the wireless module 108 and stores the plurality of package messages in the memory device 104. Then, the processor 102 determines whether the latest packet message (the package message described) stored in the memory device 104 received by a conversation window of the instant messaging software is provided with a specific content. Then, the flowchart goes to steps S20, S30, S40 and S50. At the same time, the processor 102 stores a judging result for determining whether the latest packet message is provided with the specific content in the memory device 104. The processor 102 continues to perform steps S60, S70, S80 and S90 according to the judging result in the memory device 104 when the user wants to open the conversation window. In one embodiment of the present invention, when the user is opening the conversation window (situation 2), the processor 102 determines whether the latest packet message (the package message described) is provided with the specific content directly. Then, the step is same as step S20, so the following steps are not described herein. In one embodiment of the present invention, when the user is in a multiple-person conversation window (situation 3), the processor 102 determines whether the latest packet message (the package message described) is provided with the specific content directly. For example, in a three-person (user, friend A, friend B) conversation window, the processor 102 determines whether the latest packet message of friend A or friend B is provided with specific content. The difference between situation 1 and situation 2 is that the package message and the judging result according to the package message are stored in the memory device 104 in situation 1, while the processor 102 determines whether the latest packet message received by the conversation window of the instant messaging software is directly provided with the specific content in situation 2.

The method of the present invention, or certain aspects or portions thereof, may exist in the program code. The program code can be stored in physical media, such as floppy discs, hard disk, or any other machine-readable (computer-readable) storage media, or one that is not limited to the external form of a computer program product. When the program code is executed (for example: loaded by a computer), this machine is becoming involved in the device of the present invention. The program code can also be transmitted through some transmission media, such as a wire or cable, fiber optics, or any transmission patterns used for transmission. When the program code is received, loaded and executed by a machine (such as a computer), this machine becomes an apparatus for practicing the invention. When a general-purpose processor is implemented, the program code combines with the processor to provide a unique apparatus that operates similar to application-specific logic circuits.

The previous description of the disclosure is provided to enable any person skilled in the art to make or use the disclosure. Various modifications to the disclosure will be readily apparent to those skilled in the art, and the generic principles defined herein can be applied to other variations without departing from the scope of the disclosure. Thus, the disclosure is not intended to be limited to the examples and designs described herein, but are to be accorded the widest scope consistent with the principles and novel features disclosed herein.

What is claimed is:

1. An electronic device, comprising:
a display device; and
a processor, filtering specific content from content of a packet message to serve as main content when the content of the packet message of instant messaging software is provided with the specific content, and displaying a specific input interface corresponding to a specific language on the display device when a ratio of the specific language of the main content to the main content is greater than a first predetermined value.

2. The electronic device as claimed in claim 1, wherein the packet message of the instant messaging software is a latest packet message received by a conversation window of the instant messaging software.

3. The electronic device as claimed in claim 1, wherein the specific content is at least one of a web address, a telephone number, at least one punctuation mark, and a default message.

4. The electronic device as claimed in claim 3, wherein the default message is a user-predetermined message stored in a memory device.

5. The electronic device as claimed in claim 1, wherein the processor uses the content of the package message to serve as the main content directly when the content of the packet message of the instant messaging software is not provided with the specific content.

6. The electronic device as claimed in claim 1, wherein the processor displays a control interface on the display device when the ratio of the specific language of the main content to the main content is between the first predetermined value and a second predetermined value, wherein the control interface is arranged to confirm whether a default input interface is switched to the specific input interface corresponding to the specific language, and the first predetermined value is greater than the second predetermined value.

7. The electronic device as claimed in claim 1, wherein the processor displays a default input interface on the display device when the ratio of the specific language of the main content to the main content is less than a second predetermined value, wherein the default input interface is different from the specific input interface, and the first predetermined value is greater than the second predetermined value.

8. An operation method of an electronic device, comprising:
filtering specific content from content of a packet message to serve as main content when the content of the packet message of instant messaging software is provided with the specific content; and
displaying a specific input interface corresponding to a specific language on the display device when a ratio of the specific language of the main content to the main content is greater than a first predetermined value.

9. The operation method as claimed in claim 8, wherein the packet message of the instant messaging software is a latest packet message received by a conversation window of the instant messaging software.

10. The operation method as claimed in claim 8, further comprising: displaying a default input interface on the display device when the ratio of the specific language of the main content to the main content is less than a second predetermined value, wherein the default input interface is different from the specific input interface, and the first predetermined value is greater than the second predetermined value.
